(19) United States
(12) Patent Application Publication
(10) Pub. No.: US 2015/0121678 A1
(43) Pub. Date: May 7, 2015

(54) METHOD AND DEVICE FOR CONNECTING METAL STRIPS

(71) Applicant: BWG BERGWERK- UND WALZWERK-MASCHINENBAU GMBH, Duisburg (DE)

(72) Inventors: Andreas Noé, Kerken (DE); Friedhelm Ambaum, Xanten (DE)

(21) Appl. No.: 14/381,428

(22) PCT Filed: Aug. 22, 2013
(86) PCT No.: PCT/EP2013/067430

§ 371 Date: Aug. 27, 2014

(30) Foreign Application Priority Data
Sep. 3, 2012 (DE) 102012108161.1

(51) Int. Cl. B23P 11/00; B21D 39/03

(52) U.S. Cl. CPC B23P 11/005; B21D 39/034
USPC 29/514; 29/243.5; 29/432

(57) ABSTRACT

The present invention relates to a method for connecting an end of a first metal strip to the beginning of a second metal strip, in particular in strip treatment installations, wherein the end of the strip and the beginning of the strip are positioned one on top of the other to form an overlap and are connected to one another at a number of connecting points in the region of the overlap, characterized in that the connecting points are produced by means of clinching.

The invention relates to a method as well as an apparatus for joining a trailing end of a first metal strip to the leading end of a following metal strip, particularly in a strip treatment plant or a strip process line, wherein the trailing end and the leading end are positioned over each other to form an overlap and are joined to each other at multiple connection points at the overlap.

In strip treatment plants, which are also referred to as strip mills, strip wound up into coils is generally uncoiled at the input, then passed through one or more treatment stations, and then rewound if applicable or alternatively also cut into panels at the output. So that the strips do not have to be rethreaded, the leading end of a new coil is joined to the trailing end of the preceding coil.

From practice, it is known to join the metal strips to each other by welds, trailing ends and leading ends being welded to each other at multiple spot welds. For various metal strip types, and particularly metal strips of aluminum alloys, welded joints often present problems in practice. For example, resistance spot welding for aluminum alloys poses the problem of spattering. There is also the risk of the electrode adhering to the strip, and due to the electrical connection, minimum clearances between two adjoining spot welds are required. Some alloys cannot be welded at all using resistance spot welding. The same applies to resistance seam welding, which also has the same problem of spattering for aluminum alloys and also has a low seam quality. With friction welding, poor seam qualities also result, particularly for small strip thicknesses.

For this reason, it has been proposed to set the connection points as spot welds by friction point welding. Such a method can be used universally for various metal alloys and particularly aluminum or aluminum alloys, and without any impeding burr formation in particular (see EP 2202205 [US 2011/0259244]). Regardless, friction spot welding can present problems when welding painted strips. In addition, the service life of the tools is not optimal, for example when welding aluminum to steel.

As an alternative to welding, actual practice frequently resorts to punched joints, which are also referred to as stitching and can generally be used for a strip thickness up to about 6 mm. A frequent problem in this case is the fact that during the punching process, burrs or chips that are still loose or still lightly connected to the strips result due to the cutting gap. When the strips pass through a strip process line and thereby run around processing line rollers, burrs or flitter particles can break off and remain adhered to the processing line rollers, particularly when plastic-coated rollers are involved. To prevent this, it was also proposed to adhere punched joints by adhesive tape (see DE 10 2005 037 182 [US 2007/0029039], for example).

In addition, adhesive connections are also used in actual practice, but generally only up to a strip thickness of 1 mm maximum. For greater strip thicknesses, there is the risk that the adhesive seam will be peeled open in the strip process line when passing over the rollers due to the bending stiffness of the strips. All in all, there is a need to create an alternative or improved method of joining metal strips.

Therefore, the object of the invention is to create a method of joining metal strips or leading/trailing ends of metal strips, particularly in a strip mill of the type described above, that can be used universally for various metal alloys and particularly aluminum or aluminum alloys and can be executed without forming any interfering burrs.

To attain this object and for a generic method of joining a trailing end of a first metal strip to the leading end of a following metal strip, the invention teaches that the connecting points are produced by clinching. Clinching is a method of joining metal strips/sheets without using a filler material. A clinching tool generally consists of a stamp and a die. The strips to be joined are pressed by the stamp similar to in deep-drawing under plastic deformation in or against the die. The strips are thereby joined to each other in a form-fitting (and force-fitting) manner without using rivets. The die and stamp cause a flowing of the materials width-wise at or in the die so that—similar to a riveted joint—a form-fitting joint is created, but without using (separate) rivets. Such a method of clinching is known from DE 10 2008 025 074 [US 2008/0289169], for example.

The invention is based on the discovery that metal strips can be simply and reliably joined to each other by clinching. In this way, metal strips of a diverse range of alloys and particularly also aluminum strips can be reliably joined to each other. Metal strips of various thicknesses and strengths can be joined to each other. Advantageous is the fact that only a deformation process, and no cutting process, joins the two strips to each other, so that no burrs or chips are formed. The use of clinching known per se during joining ends of metal strips, particularly in strip process lines, is consequently of particular significance within the scope of the invention. High-quality and high-strength strip joints can be produced that meet the high demands in strip mills or strip process lines. Painted or coated metal strips can also be easily joined by clinching.

At the same time, multiple, spaced-apart connection points produced transversely to the strip travel direction are preferred so as to form at least one row of connection points extending over the strip width or almost the strip width. In this way, it is practical to produce at least one row of connection points with more than 10, preferably more than 20 (for example 30 or more) connection points distributed over the strip width. In doing so, the invention is based on the knowledge that by using conventional jointing press units that are also used for punched joints, high pressing forces can be applied so that the possibility exists of setting a high number of connection points simultaneously. In doing so, it may be sufficient to join a leading end and a trailing end with only a single row of connection points. Alternatively, the invention proposes producing multiple connection points arranged one after the other in the strip travel direction, while producing multiple rows of connection points arranged one behind the other in the strip travel direction. However, it also lies within the scope of the basic invention to set the individual connection points along the strip width and/or in the strip travel direction one after the other individually or in groups. However, it is preferred to set at least one row of connection points simultaneously. Setting all rows of connection point simultaneously is particularly preferred.

The connection points are produced with a jointing press. Accordingly, the invention proposes making the entire strip joint, i.e. all connection points, with a maximum of three press strokes, preferably with only a single press stroke. For example, if two or three rows of connection point are set, the possibility exists of setting these chronologically one after the other with one press stroke each. However, it is preferred to set all rows of connection points (for example two or three rows of connection points) with a single press stroke.

By means of the method according to the invention, metal strips of diverse thicknesses can be joined. On the whole, the method can be used for a thickness range of 0.15 mm to 5 mm. It thereby lies within the scope of the invention to join strips of varying thicknesses with one and the same clinching tool. However, it is preferred that different clinching tools be used for strips of different thicknesses. For example, it may be practical to use clinching tools with various point diameters (or stamp diameters) for various strip thicknesses or strip thickness ranges. For thin strips, one can work with small point diameters, and preferably multiple connection points are then set. For thick strips, one preferably works with large point diameters, and fewer connection points are then set.

Taking into account the fact that it is practical to adapt the method to the strip properties and particularly the material and the strip thickness, the invention in a preferred enhancement proposes to select a clinching tool suited for a respective strip from several clinching tools available and to transfer it with a tool changer from a hold position outside of the jointing press into a work position within the jointing press. The possibility thereby exists of moving or shifting the clinching tools during the tool change transversely to the strip travel direction. However, the clinching tools are preferably moved parallel to the strip travel direction during the tool change process. The invention is thereby based on the knowledge that the clinching tool generally consists of an upper tool and a lower tool, so that the upper tool and the lower tool can move outside of the strip plane parallel to the strip plane. The possibility thus exists of displacing, during the tool change, the upper tool and lower tool in the strip travel direction above the strip plane and below the strip plane, so that the tool change can also be executed on the metal strip in the line, and specifically also when the upper tool and the lower tool are connected by lateral guides to a frame-type tool set, since the guides then lie outside of the strip width.

A tool changer may carry multiple clinching tools, for example. There is also the possibility of providing in addition to one or more clinching tools a conventional punching tool for a punched joint, so that the machine can be retrofitted for punching if needed. This is suited for brittle materials for example, which cannot be optimally joined by clinching.

All in all, the method according to the invention is distinguished by a high degree of flexibility.

In addition to clinching, it is also proposed to adhesively connect the trailing end and leading end, for example to adhere them to each other.

The object of the invention is also an apparatus for joining metal strips by a method of the type described. Such an apparatus is characterized by a jointing press with a pressing frame, a pressing upper part and a pressing lower part, where the press upper part carries an upper tool with at least one stamp (or one die) for the clinching process and the press lower part carries a lower tool with at least one die (or a stamp) for the clinching process, the press upper part and/or the press lower part being movable by one or more actuators (against each other) for applying a pressing force. This way, the possibility exists of moving the press upper part with the upper tool using the actuators against the stationary lower tool, or vice versa. The actuators may be hydraulic cylinders for example. Accordingly, one can also fall back on existing constructions of punch jointing presses in particular. High pressing forces can be applied so that not only individual connection points, but a plurality of connection points, particularly one or more complete rows of connection points, can be formed simultaneously.

Thus, the invention proposes that the upper tool be constructed as a multi-tool with multiple stamps (or dies) distributed over the strip width and the lower tool is constructed as a multi-tool with multiple dies (or stamps) distributed over the strip width. The upper tool and lower tool can preferably have more than 10 stamps or dies, preferably more than 20 (for example 30 or more) stamps or dies distributed across the width of the strip. If, as explained below, there is no die, i.e. work is done with a flat die, a common counter-surface may be implemented for a plurality of stamps.

Consequently, the upper tool and the lower tool form a clinching tool or a tool set, the upper tool or lower tool being connected to each other preferably via guides, for example via guide posts. In an assembled state of the tool, these guides, for example guide posts, are in the jointing press flanking the strip width.

Taking into account the fact that the method is to be adapted in a simple manner to various strips and particularly strip thicknesses, it is particularly preferred to provide a tool changer with multiple upper tools and multiple lower tools (and consequently multiple tool sets) that optionally can be transferred from a work position inside the press to a hold position outside the press and vice versa.

In an initial, preferred embodiment, the upper tools and lower tools are transferred by the tool changer parallel to the strip movement direction from the work position into the hold position and vice versa. In addition, actuators, for example hydraulic change actuators or change cylinders, can work on the tools. These variants with a parallel change direction have the advantage that the tools can also be changed when the metal strip is in the machine and subsequently in the jointing press, since the upper tool is located above the strip level and the lower tool is located below the strip level, so that the tools can be changed when the tools are connected to each other in a frame-like manner via guide posts. Alternatively, the upper tools and the lower tools can also be transferred by the tool changer transversely to the strip travel direction from the hold position into the work position and vice versa. The tool changer then has preferably at least one changing table with the tools arranged next to the press. On the changing table, multiple tools are arranged one after the other in the strip travel direction. The changing table then moves (parallel to the strip travel direction), for example by one position, and a new tool is pushed (transversely to the strip movement direction) into the press frame. To the extent an upper tool and lower tool are connected to each via guide posts, it is necessary to carry out the exchange when no metal strip is in the machine.

The tool changer makes it possible to provide multiple clinching tools or tool sets so that a simple adaptation of the machine to current conditions, particularly to varying thicknesses, can be done. In addition, the possibility exists of equipping the tool changer with an additional (conventional) punching tool so that the machine can also be converted into a punching apparatus.

As already explained, the tools for clinching generally have stamps on the one hand and dies on the other. The dies may be for example a contoured or profiled die, which can be adapted to the stamp shape. Within the scope of the invention, die also refers to completely flat dies and consequently a flat counter-tool, so that so-to-speak “die-less” clinching processes are also included.

In an optional arrangement of the invention, the strips are joined to each other by tempered clinching. Thus the metal strips to be joined are heated before and/or during the jointing process. There is also the possibility of preheating the strips themselves with suitable tempering apparatuses and then clinching them. Alternatively or in addition, tempering can also take place by the clinching tools themselves. There is also the possibility of heating the upper tool and/or the lower tool so that the strip is heated under contact pressure and is then deformed. In addition, it may be practical to work with a non-contoured die or a non-contoured counter-tool, the counter-tool and/or stamp being heatable. When heating the strips via one or both tools, it may be practical to press the strips against each other with suitable means, for example a clamping apparatus or the like prior to clinching or pressing. The possibility thereby exists of pressing the strips with a blank holder against the (heated) counter-surface in such a manner that the connection region is heated. Clinching subsequently is done by the stamp. A contact pressure during heating can also take place by the tools or stamps themselves. In the (first) heating phase, only a fixing and heating of the strips takes place, and in a (second) clinching phase the joining takes place.

In regard to tempered clinching, it is practical if the movable tool, for example the upper tool can be lined up in a position-controlled manner, and specifically in particular when the stamp has to be positioned on the strip in a heat phase for contact prewarming. In the event of contact preheating using the tool, it is also practical when the contact pressure (during heating) can be adjusted depending on the strip. By tempering (heating) the metal strips, their deformability or their deformation capability is increased so that the connection process can be optimized. This is advantageous particularly for joining brittle materials, since the deformability of brittle materials is improved by tempering. All in all, the tempering of certain materials or material combinations can be advantageous. The formation of cracks can be avoided.

The invention is explained below by means of drawings, which solely represent embodiments. Therein:

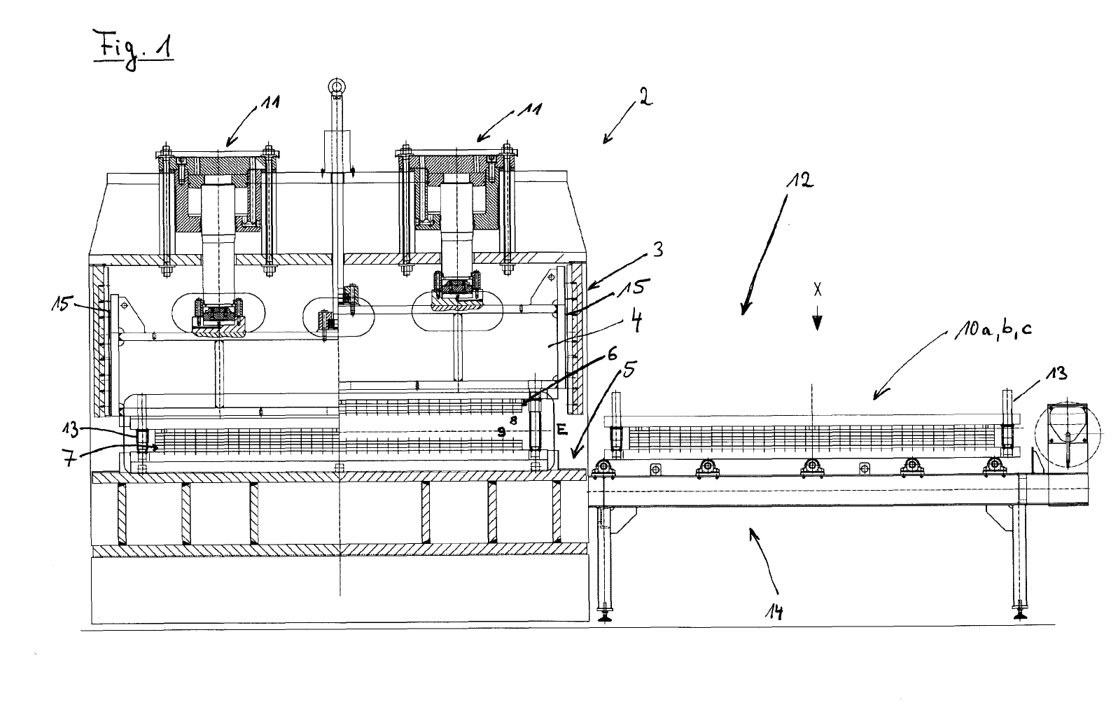

FIG. 1 is a vertical section through a first embodiment of the invention.

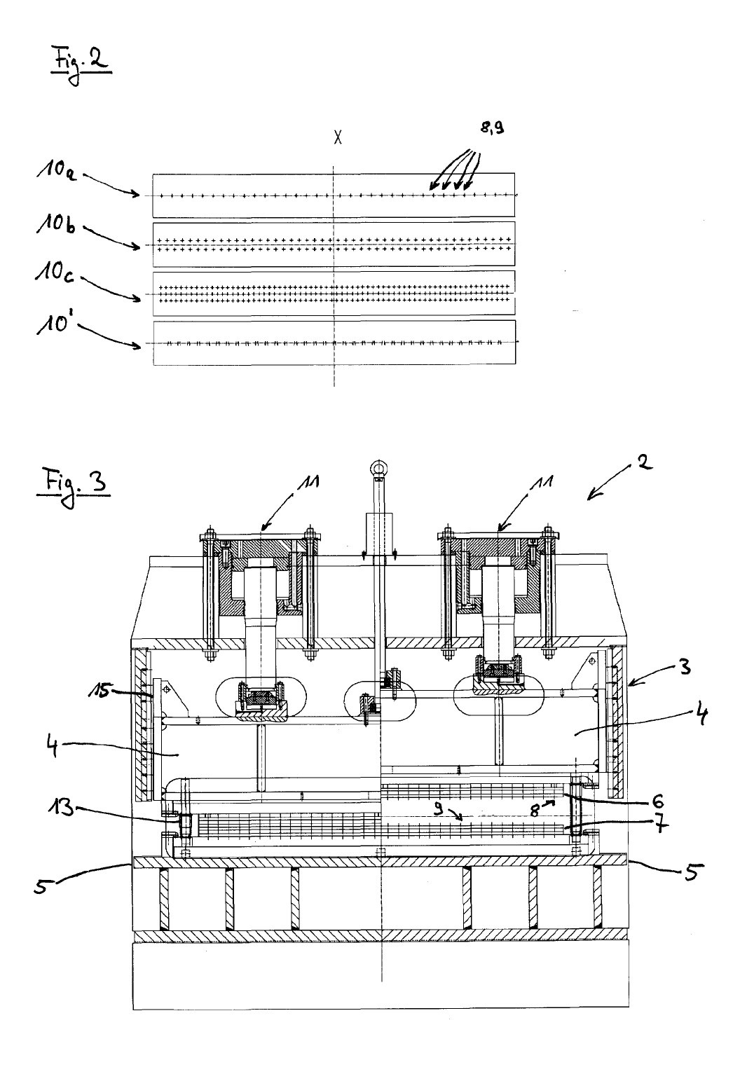

FIG. 2 is a simplified view in direction X of FIG. 1 of the invention.

FIG. 3 is a vertical section through a second embodiment of the invention.

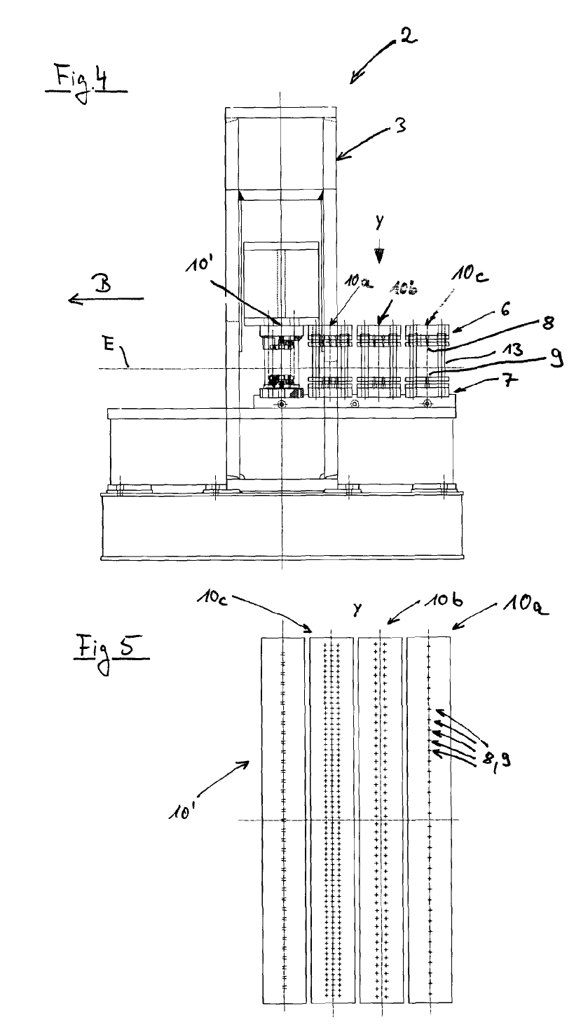

FIG. 4 is a side view of the structure of FIG. 3.

FIG. 5 is a simplified view in direction Y of FIG. 4 of the invention.

The drawings show an apparatus for joining metal strips, namely to join a trailing end of a first metal strip to the leading end of a following metal strip. Such an apparatus is preferably part of a strip mill (strip process line), for example in the intake region of such a strip process line. Coiled metal strips are uncoiled in the intake section, they then pass through various treatment stations and are recoiled or further processed at the output. So that the metal strips does not always have to be rethreaded, the leading end of a new coil is joined to the trailing end of the preceding strip. To do so, the leading end and the trailing end are positioned over each other to form an overlap and are joined to each other at the overlap at multiple connection points. Such joining processes are basically known. The metal strips are not shown in the drawings; only strip plane E is shown.

According to the invention, the connection points are produced by clinching. To do so, the apparatus has a jointing press 2 with a frame 3, a press upper part 4, and a press lower part 5. The strip travel direction B is indicated in FIG. 4; in FIGS. 1 and 3, it is perpendicular to the drawing plane. The upper part 4 carries an upper tool 6 with multiple stamps 8 for clinching. The lower part 5 carries a lower tool 7 with multiple dies for clinching. The upper tool 6 with the stamps 8 and lower tool 7 with the dies 9 form tool sets 10a, 10b, and 10c. The upper tool 6 and the lower tool 7 are each constructed as multi-tools with multiple stamps 8 and dies 9 distributed over the strip width. In the illustrated embodiments, the upper part 4 for applying the pressing force has actuators 11 that move it against the stationary press lower part 5. The actuators 11 are constructed in the embodiments as hydraulic cylinders 11 whose pistons are connected to the movable the upper part 4 and that are supported by the stationary upper beam of the press frame 3. FIGS. 1 and 3 show the press 2 in a divided view, closed in one half and open in the other half. The upper part 4 moves along guides 15 of the press frame 3.

The shown embodiments are each equipped with a tool changer 12 carrying multiple tool sets 10a, 10b, and 10c, each consisting of an the upper tool 6 and the lower tool 7. By means of this tool changer 12, the individual tool sets 10a, 10b, and 10c can be selectively transferred from a work position inside the press to a hold position outside the press, and vice versa. In this way, the possibility exists of changing the tools and adapting the apparatus to the desired conditions, for example to the current strip thickness. In a preferred manner, various tools are used for joining certain strip thicknesses.

FIGS. 1 and 2 on the one hand and FIGS. 3 to 5 on the other show two embodiments with various tool changers 12.

FIGS. 1 and 2 show a first embodiment in which the tools 6 and 7 are transferred by the tool changer 12 transversely to the strip travel direction B out of the work position into the hold position. To do so, the tool changer 12 in this embodiment is arranged laterally next to the press 2. It has a change table 14 with multiple tool sets 10a, 10b, and 10c arranged one after the other along the strip travel direction B. If the tool located in the press 2 is to be changed, it is pulled (or pushed) transversely to the strip travel direction B out of the press onto the change table 14. The change table 14 then moves parallel to the strip travel direction, for example by one position, so that another tool can be pushed (or pulled) into the press 2 transversely to the strip travel direction B.

In the simplified top view in FIG. 2, one can see in the illustrated embodiment that four different tools or tool sets 10a, 10b, 10c, and 10′ are in the tool changer 12. Three tool sets 10a, 10b, and 10c are provided for clinching with which one, two, or three rows of connection points can be set. Consequently, the first tool 10a has a row of stamps and dies, while the following tool set 10b has two rows of stamps and dies arranged one behind the other in the strip travel direction B, and the third tool set 10c has three rows of stamps and dies arranged one behind the other in the strip travel direction so that selectively one, two, or three rows of connection points can be set with a single press stroke, depending on which tool set 10a, 10b, or 10c is in the press 2. Also, an additional tool set 10′ is provided that is constructed as a punch tool 10′ so that the press can also be easily retrofitted for a punched joint. It becomes clear that various tool sets can be used, for example for various strip thicknesses or strip-thickness ranges, where the individual tool sets 10a, 10b, and 10c generally have various point diameters or stamp diameters. For thin strips, small point diameters are generally used, so then a relatively high number of connection points are set. For thick strips, large point diameters are used, so fewer points are generally set.

In doing so, one can see that the upper tool 6 and the lower tool 7 are connected to each other via guides 13 while forming tool set 10a, 10b, and 10c. In the embodiment, there are the guide posts 13, which ensure that the upper tool 6 and the lower tool 7 are properly brought together with stamps and dies into the desired position. In doing, each tool set has a total of four guide posts 13 arranged at the corners. This also applies for the embodiment according to FIGS. 1 and 2 as well as for the embodiment according to FIGS. 3 and 4.

While tool sets 10a, 10b, and 10c or 10′ are changed transversely to the strip travel direction B in the embodiment according to FIGS. 1 and 2, FIGS. 3 to 5 show a second embodiment in which tool sets 10a, 10b, and 10c or 10′ are moved along the strip travel direction B for changing purposes. The individual tool sets are in turn arranged one behind the other in the strip travel direction B; however, this time they are not laterally offset to jointing the press 2, but offset to jointing the press 2 along the strip travel direction. Nevertheless, the passage of the metal strip is not impeded, since upper tools 6 are always arranged above the metal strip or strip plane E and lower tools 7 are always arranged below the metal strip, and since the guide posts 13 are always outside of the strip region. In this embodiment, the tool set can then be changed when the strip is in the machine. FIG. 4 shows a view in which punch tool 10′ is arranged in the machine by way of example.

To enable changing tool sets 10a, 10b, 10c, and 10′, generally tool-change actuators are provided, for example hydraulic actuators that are not shown in detail in the drawings.

The tools indicated in FIGS. 2 and 5 show that by the apparatus according to the invention, multiple, spaced-apart connection points can be simultaneously produced transversely to the strip travel direction B so as to form at least one row of connection points extending over the strip width or almost the full strip width. Depending on which of the tools is used, multiple rows of connection points arranged one behind the other in the strip travel direction B can be produced simultaneously. Thus, there exists the possibility of making the entire strip joint with a single press stroke, even for closer rows of connection points. The jointing press provides sufficient pressing force with hydraulic cylinders 11.

In the embodiment shown in FIG. 1, only one change table is shown on one side of the press. In addition, a second change table can be provided on the opposite side.

The strips can be heated before and/or during clinching. To do so, suitable heaters may be provided. Details are not shown.

1. In a method of joining a trailing end of a first metal strip to the leading end of a following metal strip, particularly in a strip mill, wherein the trailing end and the leading end are positioned on top of each other so as to form an overlap and are joined to each other at the overlap at multiple connection points, the improvement comprising the step of making the connection points by clinching.

2. The method according to claim 1, wherein multiple, spaced-apart connection points are produced simultaneously transversely to the strip travel direction so as to form a row of connection points extending across the strip width or almost the full strip width.

3. The method according to claim 2, wherein multiple connection points spaced apart one behind the other in the strip travel direction are produced so as to form multiple rows of connection points arranged one after the other in the strip travel direction.

4. The method according to claim 1, wherein the connection points are produced by a jointing press with a maximum of three press strokes.

5. The method according to claim 1, further comprising the step of:
using for strips of various thicknesses clinching tools with various point or stamp diameters.

6. The method according to claim 5, wherein out of multiple clinching tools provided, one clinching tool suitable for the respective strip is selectively chosen and is transferred by a tool changer out of a hold position outside of the jointing press into a work position inside the jointing press.

7. The method according to claim 6, wherein the clinching tools are moved parallel to the strip travel direction during tool change.

8. The method according to claim 6, wherein the clinching tools are moved transversely to the strip travel direction during tool change.

9. The method according to claim 1, further comprising the step of using in addition to one or more clinching tools, a punch tool for a punched joint.

10. The method according to claim 1, wherein the leading end and trailing end are also joined to each other adhesively.

11. The method according to claim 1, further comprising the step of:
heating the strips to be joined or the tool before or during the connecting process.

12. The method according to claim 1, wherein the tool or the tools is/are arranged in a position-controlled manner.

13. An apparatus for joining a trailing end of a first metal strip to the leading end of a following metal strip, according to (previously presented) claim 1, the apparatus comprising:
a pressing frame,
a press upper part,
an upper tool with at least one stamp carried on the press upper part,
a press lower part,
to a lower tool with at least one die carried on the press lower part, one of the press parts being movable, and
an actuator coupled to the one press part to apply a pressing force by one or more actuators thereto so as to clinch the overlapped strips between the stamp and the die.

14. The apparatus according to claim 13, wherein the upper tool is constructed as a multi-tool with multiple stamps or dies distributed over the strip width or the lower tool is constructed as a multi-tool with multiple dies or stamps distributed over the strip width.

15. The apparatus according to claim 13, wherein the upper tool and lower tool are connected to each other to form a tool set via guides.

16. The apparatus according to claim 13, further comprising:
a tool changer with multiple upper tools and multiple lower tools that can be selectively transferred from a work position inside the press to a hold position outside of the press, and vice versa.

17. The apparatus according to claim 16, wherein the upper tools and the lower tools are transferred by the tool changer parallel to the strip travel direction out of the work position into the hold position, and vice versa.

18. The apparatus according to claim 16, wherein the upper tools and the lower tools are transferred by the tool changer transversely to the strip travel direction out of the work position into the hold position, and vice versa.

19. The apparatus according to claim 16, wherein the tool changer is equipped with multiple clinching tools or with one or more clinching tools as well as at least one punch tool.

20. The apparatus according to one claim 13, further comprising:
at least one tempering apparatus with which the strips or the tool or the tools can be heated before or during the joining process.
